(19) United States
(12) Patent Application Publication
(10) Pub. No.: US 2025/0145485 A1
(43) Pub. Date: May 8, 2025

(54) PROCESS FOR THE PREPARATION OF PHOSPHORUS PENTAFLUORIDE

(71) Applicant: Fluorchemie Stulln GmbH, Stulln (DE)

(72) Inventor: Thomas Franz Berger, Hirschau (DE)

(73) Assignee: Fluorchemie Stulln GmbH, Stulln (DE)

(21) Appl. No.: 18/832,849

(22) PCT Filed: Jan. 25, 2022
(86) PCT No.: PCT/EP2022/051563

§ 371 Date: Jul. 24, 2024

(51) Int. Cl. C01D 15/00; C01B 25/10; H01M 10/0568

(52) U.S. Cl. CPC C01D 15/005; C01B 25/10; C01P 2006/40; H01M 10/0568

(57) ABSTRACT

The present invention relates to processes for the preparation of phosphorus pentafluoride and lithium hexafluorophosphate.

### CROSS REFERENCE TO RELATED APPLICATIONS

This application is the U.S. national stage application of international application PCT/EP2022/051563, filed Jan. 25, 2022, which international application was published on Aug. 3, 2023, as international publication WO 2023/143692, which is incorporated herein by reference in its entirety.

### FIELD

The present invention relates to the technical field of chemical process engineering, especially large-scale synthesis, in particular the production of starting materials for electrolytes.

### SUMMARY

In particular, the present invention relates to a process for the preparation of phosphorus pentafluoride. Furthermore, the present invention relates to a process for the preparation of lithium hexafluorophosphate.

### DETAILED DESCRIPTION

Lithium hexafluorophosphate (LiPF₆) is the lithium salt of hexafluorophosphoric acid (HPF₆) and the lithium salt that is commonly used to produce electrolytes for lithium-ion batteries and lithium-ion accumulators. Hexafluorophosphoric acid is unstable, but can be obtained in aqueous form by reacting phosphoric acid with hydrofluoric acid or fluorspar (calcium fluoride, CaF₂) in the presence of sulphuric acid. However, the anhydrous salts of hexafluorophosphoric acid, in particular lithium hexafluorophosphate, are difficult or impossible to synthesize in this way. However, for the production of electrolytes, especially for lithium-ion batteries and accumulators, the raw materials used must be absolutely anhydrous in order to avoid undesirable side reaction

An important starting product for the production of anhydrous lithium hexafluorophosphate is phosphorus pentafluoride (PF₅), which is obtained on an industrial scale by reacting phosphorus pentachloride (PCl₅) in and with hydrogen fluoride (HF). Phosphorus pentafluoride is obtained from elemental phosphorus in a multi-stage synthesis: First, elemental phosphorus is reacted with elemental chlorine to form phosphorus trichloride (PCl₃), which is then specifically oxidized with elemental chlorine in a further step to form phosphorus pentachloride (PCl₅). Subsequently, chloride is exchanged for fluoride by reaction in HF, so that phosphorus pentafluoride and, as a by-product, HCl are formed. As a result, at least a three-stage reaction is necessary to obtain phosphorus pentafluoride:

P+3/2Cl₂→PCl₃ (1)

PCl₃+Cl₂→PCl₅ (2)

PCl₅+5HF→PF₅+5HCl (3)

Another disadvantage of this synthesis is that the resulting HCl must be disposed of.

Furthermore, the use of the intermediate product phosphorus pentachloride is unfavorable for other reasons: chlorinated compounds, especially reaction products, but also by-products are generally problematic from an environmental point of view and have to be disposed of at great expense. In addition, phosphorus pentachloride is highly hygroscopic and even in the absence of water decomposes rapidly into the more stable phosphorus trichloride and elemental chlorine.

Due to the properties described, PCl₅ can only be transported in small containers under inert gas. Large-scale use for the production of phosphorus pentafluoride is therefore only possible if the production of phosphorus pentafluoride takes place directly after the production of phosphorus pentachloride.

Phosphorus pentafluoride is usually reacted with lithium fluoride (LiF) in solution to obtain lithium hexafluorophosphate.

PF₅+LiF→LiPF₆ (4)

Various solvents, such as hydrogen fluoride, liquid sulphur dioxide or acetonitrile, can be used here.

In addition, processes are also known in which phosphorus pentafluoride is reacted with a lithium salt in liquid hydrogen fluoride to form lithium hexafluorophosphate.

Furthermore, DE 19 614 503 A1 describes a process for the production of lithium hexafluorophosphate, whereby calcium fluoride is first reacted with phosphorus pentachloride in an autoclave to form phosphorus pentafluoride. The phosphorus pentafluoride obtained is then reacted with a lithium salt in hydrogen fluoride to form lithium hexafluorophosphate.

However, the use of an autoclave is expensive both in terms of equipment and energy and, in addition, chlorinated starting products are again used here, so that a complex purification of the phosphorus pentafluoride obtained is necessary, since the lithium hexafluorophosphate must be free not only of water but also of chloride, especially for use in lithium-ion batteries and accumulators.

The prior art therefore still lacks a process for the production of phosphorus pentafluoride or lithium hexafluorophosphate that is easy to carry out on an industrial scale, requires a minimum number of reaction steps and is based on inexpensive, readily available and stable starting materials.

In addition, the prior art still lacks a process for the production of phosphorus pentafluoride or lithium hexafluorophosphate that does not require the use of chlorinated starting substances.

It is therefore the task of the present invention to avoid, or at least mitigate, the disadvantages associated with the prior art as described above.

In particular, one task of the present invention is to provide a process for the production of phosphorus pentafluoride and lithium hexafluorophosphate which is easy to implement on an industrial scale and which is based in particular on inexpensive and generally available starting materials.

In addition, a further task of the present invention is to provide a process for the preparation of phosphorus pentafluoride and lithium hexafluorophosphate which does not require the use of chlorinated starting materials or intermediates.

Accordingly, an object of the present invention according to a first aspect of the present invention is a process for the preparation of phosphorus pentafluoride according to claim 1; further, advantageous embodiments of this aspect of the invention are the subject of the subclaims relating thereto.

A further object of the present invention according to a second aspect of the present invention is a process for the preparation of lithium hexafluorophosphate according to claim 19; further, advantageous embodiments of this aspect of the invention are the subject of the subclaims relating thereto.

It goes without saying that special embodiments mentioned below, in particular special embodiments or the like, which are described only in connection with one aspect of the invention, also apply accordingly with respect to the other aspects of the invention, without this requiring express mention.

Furthermore, in the case of all the relative or percentage, in particular weight-related, quantities mentioned below, it should be noted that these are to be selected by the skilled person within the scope of the present invention in such a way that the sum of the ingredients, additives or auxiliary substances or the like always results in 100% or 100% by weight. However, this is self-evident to the person skilled in the art.

In addition, all the parameter data or the like mentioned below can in principle be determined or ascertained using standardized or explicitly specified determination methods or using determination methods known to a person skilled in the art.

Having said this, the object of the present invention is explained in more detail below.

An object of the present invention-according to a first aspect of the present invention—is a process for the preparation of phosphorus penta fluoride (PF₅), wherein phosphoric acid (H₃PO₄) is reacted with hydrogen fluoride (HF).

Phosphorus pentafluoride is formed or obtained by reacting phosphoric acid with hydrogen fluoride.

In particular, the process according to the invention makes it possible to obtain anhydrous phosphorus pentafluoride, which is excellently suited for the production of lithium hexafluorophosphate.

A particular advantage of the present invention is that phosphoric acid is used as the starting material, i.e. an inexpensive and industrially available substance. In the context of the present invention, a complex synthesis of the unstable phosphorus pentachloride can thus be dispensed with.

Furthermore, the use of chlorine and chlorinated substances can generally be dispensed with in the context of the present invention. On the one hand, this is preferable from the point of view of environmental protection and, on the other hand, also enables significantly simpler processing of the products obtained, since these do not first have to be separated from chlorinated by-products at great expense.

As explained above, the reaction of phosphoric acid with hydrogen fluoride, also known as hydrogen fluoride, produces phosphorus pentafluoride. Water is formed as a further product of the reaction, but this is bound in particular by unreacted or excess hydrogen fluoride, respectively. During the reaction of phosphoric acid and hydrogen fluoride, an equilibrium is quickly established between reactants and products, but with suitable reaction control it is possible to run the reactions quantitatively with regard to the phosphoric acid used. For this purpose, it is preferable to work with a large excess of hydrogen fluoride, as the equilibrium of the reaction

H₃PO₄+5HF [symbol] PF₅+4H₂O (5)

is then completely on the side of the products, i.e. on the right-hand side.

Phosphorus pentafluoride has a boiling point of −84.6° C., whereas pure hydrogen fluoride has a boiling point of 19.5° C., so that the phosphorus pentafluoride formed can be easily separated from the reaction mixture by distillation. This is a further advantage of the process according to the invention. Any hydrogen fluoride carried along during the separation of the phosphorus pentafluoride can then preferably be physically separated from the phosphorus pentafluoride, for example by distillation.

In order to achieve the most complete possible conversion of the phosphoric acid, it is advantageous if the water content is kept as low as possible during the entire reaction, i.e. if both the reactants have the lowest possible water content and the amount of water formed during the reaction is low in relation to the hydrogen fluoride (hydrogen fluoride) used.

In the context of the present invention, it has proved particularly useful if the reaction mixture has a water content of less than 10% by weight, in particular less than 5% by weight, preferably less than 3% by weight, based on the reaction mixture. If possible, these water contents are maintained over all process stages for the production of phosphorus pentafluoride, i.e. are not exceeded at any process stage. Exceeding should only occur, if at all, after removal of the phosphorus pentafluoride from the reaction mixture.

Particularly good results are obtained in the context of the present invention if the hydrogen fluoride used has a water content of less than 5 kg/t, in particular less than 2 kg/t, preferably less than 1 kg/t, preferably less than 500 g/t. The content refers in each case to the total amount of hydrogen fluoride and water, i.e. the hydrogen fluoride contaminated with water.

Particularly preferably, the hydrogen fluoride used is anhydrous. In the context of the present invention, anhydrous hydrogen fluoride is to be understood as hydrogen fluoride which contains less than 100 g of water per ton (100 g/t), based on the weight of the hydrogen fluoride which may contain water.

The above-mentioned water contents of the hydrogen fluoride indicate ranges in which very good results are obtained and with which the hydrogen fluoride should preferably be introduced into the process. If the hydrogen fluoride is used several times or repeatedly, for example in batch operation, but also in continuous process control, higher water contents can also be used in subsequent process cycles, as explained below.

In the context of the present invention, it is usually envisaged that the hydrogen fluoride is used in liquid form.

Furthermore, it is also preferably provided in the context of the present invention that the hydrogen fluoride is used in excess. In the context of the present invention, hydrogen fluoride is preferably used both as a reactant and as a solvent. As already explained above, the large excess of hydrogen fluoride makes it possible to shift the reaction equilibrium completely or almost completely to the side of the products, so that the phosphoric acid used is converted to phosphorus pentafluoride quantitatively as far as possible. The excess of hydrogen fluoride is preferably so large that the above-mentioned water contents of the reaction mixture are not exceeded.

As previously stated, it is preferred in the context of the present invention if the reactants used have the lowest possible water content.

As far as the phosphoric acid is concerned, it may be envisaged in the context of the present invention that the phosphoric acid has a water content of at most 20% by weight, in particular at most 15% by weight, preferably at most 10% by weight, preferably at most 5% by weight, more preferably at most 2% by weight, most preferably at most 1% by weight, relative to the phosphoric acid, which may contain water, i.e. the mixture of H₃PO₄ and water. With respect to the phosphoric acid, it is thus naturally also preferred if the phosphoric acid has the lowest possible proportion of water.

However, it is also readily possible within the scope of the present invention to use commercially available 85% phosphoric acid as a starting material. This can also be converted with a large excess of hydrogen fluoride to anhydrous phosphorus pentafluoride, which can be easily removed from the reaction mixture. Due to the high hydration enthalpy of hydrogen fluoride, however, it is preferred if the reactants are as low in water as possible or even anhydrous, as otherwise the reaction mixture must be cooled considerably to prevent uncontrolled outgassing of phosphorus pentafluoride and/or hydrogen fluoride from the reaction mixture.

It is particularly preferred in the context of the present invention if the phosphoric acid is anhydrous. Anhydrous phosphoric acid is a solid and can be used as a fine powder. The best results are obtained when anhydrous phosphoric acid is used.

According to a preferred embodiment of the present invention, it is provided that the phosphoric acid is added to the hydrogen fluoride in fine distribution and/or in small quantities. Incorporation of the phosphoric acid in fine distribution and/or in small quantities into the hydrogen fluoride, in particular into a large excess of hydrogen fluoride, has the advantage that the heat of reaction is quickly dissipated and the reaction proceeds completely to the phosphorus pentafluoride.

Similarly, in the context of the present invention, it is preferably provided that the phosphoric acid is added to the hydrogen fluoride with mixing.

Furthermore, it is preferred if the mixing of the reaction mixture is continued over the entire reaction period.

In the context of the present invention, mixing means in particular stirring, in particular constant stirring, of the reaction mixture or injecting the phosphoric acid into the hydrogen fluoride. By preferably strongly and constantly mixing the reaction mixture, side reactions can be avoided, in particular if the phosphoric acid is added to the hydrogen fluoride in finely divided or small quantities. In particular, an oligomerization or polymerization of the phosphoric acid can be observed as a side reaction, which occurs when the hydrophilic effect of the hydrogen fluoride is stronger than the addition of the fluoride to the phosphoric acid. However, this side reaction can be effectively counteracted by vigorous stirring or mixing of the reaction mixture. If the phosphoric acid introduced is immediately finely dispersed in a large excess of hydrogen fluoride, complete conversion to phosphorus pentafluoride is observed. If, on the other hand, the phosphoric acid is not distributed quickly enough, in particular if the reaction mixture is not sufficiently mixed, the described polymerization reactions are observed. These side reactions and their products do not interfere with the further course of the reaction, as the polymerized phosphorus compounds remain in the reaction mixture, but they do reduce the yield.

In addition, if the reaction is carried out unfavorably, the reaction may not proceed completely to phosphorus pentafluoride, but only to phosphorus oxide trifluoride (POF₃). Here too, however, the formation of POF₃ can be prevented by a large excess of hydrogen fluoride. A high excess of hydrogen fluoride and a low water content favor the conversion to PF₅. However, POF₃ does not interfere with the reaction, but merely reduces the yield. Since POF₃ has a boiling point of −39.7° C., which is significantly higher than that of PF₅ at −84.6° C., the choice of outgassing conditions or distillation conditions, respectively, can also be used to ensure that only PF₅ is selectively removed from the reaction mixture.

As far as the temperature at which the reaction is carried out is concerned, this is usually carried out at temperatures below the boiling point of hydrogen fluoride, i.e. below 19.5° C. It has proved useful if the reaction is carried out at temperatures of less than 15° C., in particular less than 10° C., preferably less than 5° C. In the context of the present invention, it is thus preferred if the reaction conditions, in particular the reaction temperature, remain below the boiling point of pure hydrogen fluoride. However, if the reaction is carried out under pressure, higher temperatures may well be chosen.

In the context of the present invention, it is usually envisaged that, following the reaction of the phosphoric acid with the hydrogen fluoride, the phosphorus pentafluoride formed is removed from the reaction mixture.

In this context, it has proven to be advantageous if phosphorus pentafluoride is removed from the reaction mixture via the gas phase. As already mentioned, phosphorus pentafluoride has a boiling point of −84.6° C., whereas hydrogen fluoride has a boiling point of 19.5° C., so that a distillative separation, i.e. separation via the gas phase, is readily possible. Due to the accumulation of water in the hydrogen fluoride during the reaction with the phosphoric acid and especially when using aqueous solutions of phosphoric acid, in particular 85% phosphoric acid, the boiling point of hydrogen fluoride is still significantly higher than the boiling point of pure hydrogen fluoride. However, phosphorus pentafluoride forms hydrogen bonds with hydrogen fluoride, so that a certain amount of energy must be supplied to isolate the phosphorus pentafluoride so that phosphorus pentafluoride can be removed from the reaction mixture, in particular so that it passes into the gas phase. According to the invention, it has proved useful if the phosphorus pentafluoride is removed from the reaction mixture at temperatures of less than 25° C., in particular less than 22° C., preferably less than 20° C.

Similarly, in the context of the present invention, it may be envisaged that the phosphorus pentafluoride is removed from the reaction mixture at temperatures in the range from −30° C. to 25° C., in particular −20° C. to 22° C., preferably-15 to 20° C., preferably −10° C. to 19.5° C.

The reaction mixture can thus be heated until the boiling point of pure hydrogen fluoride is reached, or even slightly higher. The boiling point of pure hydrogen fluoride at normal pressure is 19.5° C., as explained above, i.e. at normal pressure the reaction mixture can be heated to 19.5° C. or even slightly above in order to remove the phosphorus pentafluoride from the reaction mixture. However, it is also possible to work with pressurization and increased temperature.

Furthermore, it has proved useful in the context of the present invention if the phosphorus pentafluoride is removed from the reaction mixture in a process step following the reaction of the phosphoric acid with the hydrogen fluoride, in particular a second process step (b). Although it is in principle also possible, due to the high difference in the boiling points of phosphorus pentafluoride and hydrogen fluoride, to remove the phosphorus pentafluoride from the reaction mixture immediately after formation, in particular to transfer it to the gas phase, it is difficult to set reproducible and controlled conditions in this case. Preferably, therefore, the removal of the phosphorus pentafluoride from the reaction mixture is implemented in a process step following the reaction.

According to a preferred embodiment of the present invention, it is provided that
(a) in a first process step, phosphoric acid (H₃PO₄) is reacted with hydrogen fluoride (HF) to form phosphorus pentafluoride,
(b) in a second process step following the first process step (a), the phosphorus pentafluoride formed in process step (a) is removed from the reaction mixture.

For this particular and preferred embodiment of the present invention, all the aforementioned features, characteristics and advantages described in connection with the other embodiments apply accordingly.

In the context of the present invention, it has furthermore proved useful if the process, in particular process step (a), is carried out continuously or discontinuously, preferably continuously. The process according to the invention can be carried out discontinuously, i.e. in batch mode, for example by introducing liquid hydrogen fluoride into a reactor and adding phosphoric acid while stirring vigorously. After completion of the reaction, the reaction mixture is then heated so that phosphorus pentafluoride specifically passes into the gas phase and is removed from the reaction mixture.

In the context of the present invention, however, it is preferred if the process control, in particular the reaction of the phosphoric acid with the hydrogen fluoride, is continuous, for example in a tube reactor, wherein the reaction of phosphoric acid and hydrogen fluoride is first carried out with mixing and then the phosphorus pentafluoride formed is removed from the reaction mixture, preferably in a further continuous process, for example in a further section of the tube reactor or in a further tube reactor.

In the context of the present invention, it is advantageously envisaged that following the removal of the phosphorus pentafluoride, in particular in a third process step (c), the hydrogen fluoride containing water is reused or treated.

In the context of the present invention, it is preferably envisaged that the hydrogen fluoride used, which is contaminated with water and possibly phosphorus compounds after the reaction has been carried out, is reused, in particular for further renewed reaction with phosphoric acid. Any contamination with phosphorus compounds do not interfere with this, but the water content is critical.

Thus, the hydrogen fluoride should not contain more than 2% by weight, in particular not more than 1% by weight, preferably not more than 0.5% by weight, of water, based on the total amount of water and hydrogen fluoride. If the water content is higher, it becomes particularly difficult to achieve a complete conversion of phosphoric acid to phosphorus pentafluoride. If the water content becomes too high, anhydrous hydrogen fluoride can easily be distilled off from the remaining reaction mixture, the so-called sump, after removal the phosphorus pentafluoride and then used again to produce phosphorus pentafluoride. What remains is an aqueous hydrofluoric acid, which can be used for a wide variety of commercial purposes, if necessary after removal of phosphorus-containing impurities.

In the context of the present invention, it is thus preferably provided that
(a) in a first process step, phosphoric acid (H₃PO₄) is reacted with hydrogen fluoride (HF) to form phosphorus pentafluoride,
(b) in a second process step following the first process step (a), the phosphorus pentafluoride formed in process step (a) is removed from the reaction mixture,
(c1) if appropriate, returning the hydrogen fluoride obtained in process step (b) to process step (a), in particular until the hydrogen fluoride has a water content of at most 2% by weight, preferably at most 1% by weight, preferably at most 0.5% by weight, based on the hydrogen fluoride containing water, or
(c2) if appropriate, treating the hydrous hydrogen fluoride obtained in process step (b).

The hydrogen fluoride prepared in process step (c2) can then be reused in process step (a) or used for other purposes.

In the context of the present invention, recirculation in process step (a) means in particular that in batch operation, after removal of the phosphorus pentafluoride, further phosphoric acid is added to the hydrogen fluoride still in the reactor. In continuous process control, recirculation in process step (a) is to be understood in particular to mean that the water-containing hydrogen fluoride remaining after removal of the phosphorus pentafluoride is reacted again with phosphoric acid, in particular is reintroduced into the reactor to produce the phosphorus pentafluoride by reaction with phosphoric acid.

The phosphorus pentafluoride obtained in the context of the present invention is anhydrous and does not contain any chlorine-containing impurities, so that it is excellently suited for the production of lithium hexafluorophosphate. Suitable processes for the production of lithium hexafluorophosphate are known in the prior art. In particular, it is possible to obtain lithium hexafluorophosphate by reacting lithium salts, in particular lithium fluoride, with phosphorus pentafluoride in liquid hydrogen fluoride.

A further object of the present invention-according to a second aspect of the present invention, is a process for the preparation of lithium hexafluorophosphate (LiPF₆), wherein phosphorus pentafluoride obtained by the process described above is reacted with a lithium salt.

In the context of the present invention, it is preferred if the lithium salt is selected from lithium carbonate, lithium sulfate, lithium fluoride and mixtures thereof. Preferably, the lithium salt is lithium fluoride.

Preferably, it is provided in the context of the present invention that the reaction of the phosphorus pentafluoride with the lithium salt is carried out in solution, in particular in a solvent. Particularly good results are obtained in this context if the solvent is selected from the group of hydrogen fluoride, sulfur dioxide, acetonitrile and mixtures thereof, in particular hydrogen fluoride, preferably liquid hydrogen fluoride.

According to a preferred embodiment of the present invention, it is provided that
(A) in a first process step, phosphoric acid (H₃PO₄) is reacted with fluorine hydrogen (HF) to form phosphorus pentafluorides,
(B) in a second process step following the first process step (A), the phosphorus pentafluoride formed in process step (A) is removed from the reaction mixture, and
(C) reaction of the phosphorus pentafluoride obtained in process step (B) with a lithium salt, in particular in liquid hydrogen fluoride, so that lithium hexafluorophosphate is formed.

For this particular embodiment of the present invention, all the aforementioned advantages, features and characteristics mentioned in connection with further embodiments apply accordingly.

In a further preferred embodiment of the present invention, it is provided that phosphorus pentafluoride is formed in a first process step, wherein
I)
   (a) in a first process step, phosphoric acid (H₃PO₄) is reacted with hydrogen fluoride (HF) to form phosphorus pentafluoride,
   (b) in a second process step following the first process step (a), the phosphorus pentafluoride formed in process step (a) is removed from the reaction mixture,
   (c1) if appropriate, recycling the hydrogen fluoride obtained in process step (b) to process step (a), in particular until the hydrogen fluoride has a water content of at most 2% by weight, preferably at most 1% by weight, preferably at most 0.5% by weight, based on the hydrogen fluoride containing water, or
   (c2) if appropriate, treatment of the hydrous hydrogen fluoride obtained following process step (b),
II) in a subsequent process step, the phosphorus pentafluoride obtained in process step (b) of process step I is reacted with a lithium salt, in particular lithium fluoride, preferably in liquid hydrogen fluoride, so that lithium hexafluorophosphate is obtained.

All the aforementioned advantages, features and characteristics described in connection with the other embodiments apply to this particular embodiment.

For further details on this aspect of the invention, reference can be made to the above remarks on the process for the preparation of phosphorus pentafluoride according to the invention, which apply correspondingly with regard to the process for the preparation of lithium hexafluorophosphate.

1. A method for the preparing phosphorus pentafluoride (PF₅), the method comprising reacting phosphoric acid (H₃PO₄) with hydrogen fluoride (HF) to form a reaction mixture comprising phosphorus pentafluoride (PF₅).

2. The method according to claim 1, wherein the reaction mixture has a water content of less than 10% by weight based on the reaction mixture.

3. The method according to claim 1, wherein the hydrogen fluoride has a water content of less than 5 kg/t.

4. The method according to claim 1, wherein the hydrogen fluoride is used in liquid form.

5. The method according to claim 1, wherein the hydrogen fluoride is used in excess.

6. The method according to claim 1, wherein the phosphoric acid has a water content of at most 20% by weight.

7. The method according to claim 6, wherein the phosphoric acid is anhydrous.

8. The method according to claim 1, wherein the phosphoric acid is added to the hydrogen fluoride in fine distribution and/or in small quantities.

9. The method according to claim 1, wherein the phosphoric acid is added to the hydrogen fluoride with mixing.

10. The method according to claim 1, wherein the reaction is carried out at temperatures of less than 1515° C.

11. The method according to claim 1, further comprising removing the phosphorus pentafluoride from the reaction mixture.

12. The method according to claim 11, wherein the phosphorus pentafluoride is removed from the reaction mixture via a gas phase.

13. The method according to claim 11, wherein the phosphorus pentafluoride is removed from the reaction mixture at temperatures of less than 25° C.

14-15. (canceled)

16. The method according to claim 1, wherein the reacting the phosphoric acid (H₃PO₄) with the hydrogen fluoride (HF) is carried out continuously.

17. The method according to claim 11, further comprising, following the removal of the phosphorus pentafluoride, reusing or treating the hydrogen fluoride.

18. A method for the preparing phosphorus pentafluoride (PF₅), the method comprising:
(a) reacting phosphoric acid (H₃PO₄) with hydrogen fluoride (HF) to form a reaction mixture comprising phosphorus pentafluoride;
(b) removing the phosphorus pentafluoride formed in process step (a) from the reaction mixture; and
returning the hydrogen fluoride obtained in process step (b) to process step (a) until the hydrogen fluoride formed in process step (a) has a water content of at most 5% by weight based on the hydrogen fluoride containing water, and/or treating the hydrogen fluoride containing water obtained in process step (b).

19. A method for the preparing lithium hexafluorophosphate (LiPF₆), the method comprising reacting the phosphorus pentafluoride formed from the method of claim 1 with a lithium salt.

20. The method according to claim 19, wherein the lithium salt is selected from lithium carbonate, lithium sulfate, lithium fluoride and mixtures thereof.

21. The method according to claim 19, wherein the reaction of the phosphorus pentafluoride with the lithium salt is carried out in solution.

22. The method according to claim 21, wherein the solution includes a solvent selected from the group of hydrogen fluoride, sulphur dioxide, acetonitrile and mixtures thereof.
